(19) United States
(12) Patent Application Publication
(10) Pub. No.: US 2026/0220056 A1
(43) Pub. Date: Jul. 30, 2026

(54) METHODS AND APPARATUS FOR CHIP SELECTING TECHNIQUES

(71) Applicant: Intel Corporation, Santa Clara, CA (US)

(72) Inventors: Arjun KRIPANIDHI, Cupertino, CA (US); George VERGIS, Portland, OR (US); Hussein ALAMEER, Hillsboro, OR (US)

(21) Appl. No.: 19/630,554

(22) Filed: Mar. 27, 2026

(51) Int. Cl. G06F 13/16

(52) U.S. Cl. CPC G06F 13/1689; G06F 13/1673

(57) ABSTRACT

An apparatus includes: an interface comprising a first signal path and a second signal path coupled to a memory device; a controller configured to: determine a memory selection configuration represented by a plurality of bits; drive the first signal path, within a first time unit interval, to a state indicating a memory selection operation associated with the plurality of bits; drive the first signal path, within a second time unit interval consecutive to the first time unit interval, to an encoded state indicating a first bit of the plurality of bits; and drive the second signal path to an encoded state indicating a second bit of the plurality of bits within the first time unit interval or the second time unit interval.

### BACKGROUND

Memory controllers manage the flow of data between processors and system memory and must satisfy stringent electrical and timing constraints while supporting high bandwidth, low latency access in modern computing systems. As memory capacity is increased by populating multiple dual in-line memory modules (DIMMs), each including several ranks of dynamic random-access memory (DRAM) devices, the aggregate capacitive loading and signal integrity challenges on command, address, and clock lines can limit achievable data rates and system scalability.

To alleviate this loading, it is known to interpose a buffer device between the memory controller and one or more ranks of DRAM on a memory module, such that the memory controller drives the buffer and the buffer in turn drives the individual ranks, thereby reducing the electrical load directly presented to the controller. In registered DIMM (RDIMM) architectures, such a buffer is commonly implemented as a registering clock driver, which receives command, address, and clock signals from the memory controller and re-drives registered versions of those signals to the ranks of the memory circuit on the module.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 illustrates a block diagram of an example memory controller and registered DIMM interface in accordance with aspects described herein;

FIG. 3 illustrates a block diagram of a system as described herein;

FIG. 4 illustrates a physical layout diagram of an example memory module in accordance with aspects described herein;

FIG. 5 illustrates a cascaded buffer apparatus configuration in accordance with aspects described herein;

FIG. 6 shows an example of a method;

FIG. 7 shows an example of a method.

### DESCRIPTION

The present disclosure relates generally to memory systems for computing infrastructure, and more particularly to registered dual inline memory module (RDIMM) architectures, memory interface signaling protocols, chip select signal encoding techniques employed in registered memory architectures, and methods for improving memory capacity scaling in datacenter and high-performance computing environments without degrading memory controller-to-DRAM propagation delay characteristics.

DRAM can serve as the fundamental volatile memory layer for modern computing infrastructure, and demand for both memory capacity and bandwidth has grown exponentially as datacenter and high-performance computing (HPC) workloads have grown in scale and complexity. Hyperscale cloud providers and enterprise server operators face sustained pressure to provision greater amounts of memory per compute node to support memory-intensive applications including large-scale artificial intelligence (AI) model training, large language model (LLM) inference, in-memory database processing, and real-time analytics.

Server-grade memory subsystems can employ RDIMMs rather than the unbuffered DIMMs (UDIMMs) commonly found in consumer desktop systems. An RDIMM may include a buffer between a host processor or a memory controller, and memory circuits storing data. This buffer may be referred to a Registering Clock Driver (RCD), which is placed electrically between the host memory controller and the DRAM devices populating the module. Although aspects proposed herein are described by presenting the RCD as an example of such a buffer, these aspects are applicable to any other memory architectures including a buffer between the memory controller and the memory circuits storing data.

In a UDIMM topology, command and address signals driven by the memory controller are presented directly to every DRAM chip on the module, and as the number of chips grows to accommodate greater capacity, the resulting capacitive load on the memory controller output drivers degrades signal integrity and limits achievable operating frequency. The RCD resolves this problem by buffering the Command/Address (CA) bus and the clock signals: the RCD can receive signals from the memory controller on its input interface, regenerate and re-drive those signals from its output interface to the DRAM devices, and in so doing it can electrically isolate the memory controller from the aggregate load of the DRAM array. This isolation enables higher operating frequencies, longer modules populated with more DRAM devices, and greater aggregate module capacity than would be achievable in an unbuffered topology. The time a signal takes to propagate from the RCD input to the RCD output, which is referred to as the RCD propagation delay, denoted tPDM, is a critical performance metric because this delay accumulates with every memory transaction and contributes directly to system memory access latency.

A "memory controller" may refer to a host-side component configured for issuing commands to DRAM devices, managing address mapping, scheduling memory transactions, coordinating data transfer, and orchestrating refresh operations necessary to preserve data in volatile DRAM cells. The memory controller presents a physical signal interface to DRAM (e.g., RDIMM) including multiple signal groups including command/address signals, chip select signals, clock signals, and data signals. A fundamental timing parameter in DDR (Double Data Rate) memory signaling is the "time unit interval", abbreviated UI. In DDR signaling, data is transferred on both the rising edge and the falling edge of a differential clock signal, which means that two data transfers, and therefore two UIs, occur within each clock cycle. Accordingly, one UI is defined as one-half of a clock cycle (tCK/2). At a transfer rate of DDR6-12800 MT/s, for example, one UI is approximately 78 picoseconds. The UI is the fundamental granularity for describing command timing, signal state duration, and propagation delay relationships in DDR memory interface specifications.

Memory signaling schemes may be categorized according to whether information is conveyed at Single Data Rate (SDR) or Double Data Rate (DDR). In SDR operation, a signal conveys one bit of information per clock cycle, with the signal state sampled or registered on a single edge of the clock, which may typically be the rising edge, while remaining stable across both UIs of the clock cycle. Accordingly, an SDR signal consumes two UIs to convey a single bit. In DDR operation, a signal conveys information on both the rising and falling edges of the clock, delivering one bit per UI and therefore two bits per clock cycle. A chip select (CS) signal is a control signal asserted by the memory controller to indicate that a valid memory command is being presented on the CA bus and to designate which set of DRAM devices (e.g., which rank) is the target of that command. In conventional DDR memory architectures, chip select signals may perform two conceptually distinct functions: a command latching function, which notifies the receiving device that a valid command is present (and should be captured), and a rank identification function, which communicates which specific rank the memory controller intends to address.

In some examples, the CS signal has been extended beyond a single-purpose command latch to carry embedded rank-selection information, a technique that may be referred to as an "encoded chip select" scheme. In an encoded chip select architecture, the CS signal does not merely assert a binary active or inactive state; rather, the logic state of the CS signal during specific time unit intervals conveys binary bit values that together encode the identity of the target rank. This encoding separates the command latching function, indicating that a valid command is present, from the rank encoding function, conveying which rank is targeted. The distinction between these two functions is central to understanding how the number of bits that can be conveyed via the CS interface within a given time window determines the maximum number of ranks that can be addressed without introducing additional latency.

A "memory selection configuration" may refer to the specific rank that is the target of a memory operation, expressed as a binary bit pattern. For a memory subsystem with N ranks, log₂(N) bits are required to uniquely identify the target rank, since each additional bit doubles the number of distinguishable rank addresses. For N=2, one bit suffices; for N=4, two bits are required; and for N=8, three bits are required. A "rank" may be defined as a group of DRAM devices that are accessed simultaneously to fill the full width of the memory data bus. A single-rank module contains one such group; a dual-rank module contains two independently addressable groups sharing the same data bus; quad-rank and octal-rank modules extend this principle to four and eight independently addressable groups, respectively. Larger rank counts enable higher module capacities when using DRAM devices of a given per-device density. "Propagation delay" in the RCD context specifically can refer to the tPDM parameter, which may be defined as the elapsed time between the moment an input signal crosses the reference voltage threshold at an RCD input pin and the moment the corresponding regenerated signal crosses the reference voltage threshold at the corresponding RCD output pin. Minimizing tPDM is a primary design objective because each increment of tPDM directly increases memory access latency.

The registered DIMM topology may be characterized by two distinct electrical interfaces. A "front interface" which can connect the memory controller to the RCD input, and the "back interface" which can connect the RCD output to the DRAM devices. Signals presented by the memory controller on the front interface can include the frontside chip select signals (DCS), the frontside command/address bus (DCA), and the frontside differential clock (DCK). These signals are received and buffered by the RCD, which re-drives corresponding signals on the back interface: the backside chip select signals (QCS), the backside command/address bus (QCA), and the backside differential clock (QCK). The DCA and QCA buses can carry operation codes identifying the type of memory command being issued, such as ACTIVATE, READ, WRITE, PRECHARGE, or REFRESH—as well as address fields identifying the memory row, column, or bank target of the operation. The RCD may be configured for buffering these signals but also for decoding the rank-selection information embedded in the DCS signals and using that decoded information to assert the appropriate QCS signal on the back interface to activate the correct rank.

A "pass-through mode" may refer to an operating mode in which the RCD forwards signals received on the frontside input interface directly to the backside output interface without performing internal rank-selection decoding. In pass-through mode, the DCS and DCA signals received on the RCD frontside are reproduced on the QCS and QCA backside outputs as received, and the DRAM devices or other downstream components are responsible for interpreting rank-selection information. This mode may be applicable in architectures where the DRAM device itself contains internal decoding logic, such as in 3D Stacked (3DS) DRAM configurations, where a base die manages the selection of stacked core dies, and where it is therefore unnecessary or undesirable for the RCD to perform additional decoding. A "sideband interface" may refer to a secondary communication channel, physically distinct from the main high-speed DCS, DCA, and DCK signal paths, that allows a host controller or test system to communicate configuration, control, and diagnostic information to the RCD. Sideband interfaces in DDR memory architectures may employ lower-speed serial protocols such as I²C, I3C, SPI, or UART, providing a management plane through which mode registers within the RCD can be written and read without occupying the primary high-speed memory interface.

The JEDEC DDR6 standard represents the current generation of server-grade memory interface specifications, targeting data transfer rates ranging from approximately 8,800 MT/s to 17,600 MT/s and introducing a 4×24-bit sub-channel architecture per DIMM to manage electrical loading at these higher frequencies, which becomes 4×30-bit configuration with ECC die. As part of the DDR6 specification, there may be an encoded chip select scheme that uses two physical CS pins, i.e., DCS0 and DCS1, to convey both the command latch and rank-selection bits, with the goal of supporting higher rank counts without increasing the number of physical CS pins. Under the DDR6 encoded CS scheme applicable to four-rank modules, DCS0 operates traditionally in SDR mode and performs the command latching function, while DCS1 operates in DDR mode and carries two rank-selection bits in the first two UIs of the command cycle. This transition from a scheme in which each physical rank has a dedicated CS pin to an encoded CS scheme in which multiple bits on shared pins identify the target rank represents the industry's response to the pin-count constraint faced by high-rank-count RDIMM architectures.

To increase the storage capacity of a memory module, may include increasing the number of ranks per module. For example, a dual-rank module offers twice the capacity of a single-rank module at equivalent die density, and an octal-rank module offers eight times the capacity. Increasing rank count can therefore be an attractive and cost-effective scaling path because it leverages existing DRAM die manufacturing without requiring process node advancement. However, as rank count increases, the encoded chip select scheme used to convey rank-selection information to the RCD introduces timing constraints that create performance penalties beyond four ranks.

In Case 1, DCS0 operates in SDR mode across UI0 and UI1 for command latching, while DCS1 delivers two rank-selection bits in DDR mode across those same two UIs. Because two bits suffice for four-rank selection, the RCD possesses all decoding information by the end of UI1 and can assert QCS immediately, achieving optimal tPDM without any wait state. In Case 2, three rank-selection bits are required for eight-rank selection, but DCS0 remains in SDR mode and DCS1 can deliver only two bits within UI0 and UI1. The third bit cannot be transmitted until UI2, forcing the RCD to stall its decoding pipeline for one additional UI. This mandatory wait state increases tPDM by one UI relative to the four-rank Case 1 baseline, adding latency to every memory transaction on an eight-rank module.

The one-UI tPDM penalty can carry a further consequence for command bandwidth. Because the third rank-selection bit arrives in UI2, the memory controller must extend the PRECHARGE command from two UIs to four UIs to maintain correct bit-to-command association. A command nominally occupying one clock cycle is forced to occupy two, degrading command bandwidth by up to sixteen percent, which is a material penalty in AI and datacenter workloads where sustained command throughput is critical. Alternative architectures such as MRDIMMs and MCDIMMs address capacity and bandwidth demands through data-path multiplexing, but they do not resolve the buffer-related propagation delay (i.e. RCD propagation delay) problem inherent the configurations, and they introduce substantially greater module cost, power consumption, and complexity.

In various aspects described herein, the first chip select signal path, e.g., DCS0, may be operated in DDR encoded mode rather than SDR mode, repurposing the second UI of the DCS0 signal cycle to carry an additional rank-selection bit. Combined with the two bits conveyed by the second chip select signal path, e.g., DCS1, across UI0 and UI1, all three bits required for eight-rank decoding can be delivered within two consecutive UIs. The RCD thereby can possess complete rank-selection information at the end of UI1 and can assert QCS without any wait state, achieving a tPDM identical to that of a four-rank configuration.

Various aspects described herein can addresses the command bandwidth degradation that accompanies the conventional eight-rank approach. Because the conventional scheme can require a third rank-selection bit in UI2, two-UI commands such as PRECHARGE must be stretched to four UIs, degrading command bandwidth by up to sixteen percent. By delivering all three rank-selection bits within the standard two-UI window, techniques described herein can eliminate the need to extend any command duration. Commands defined as two-UI operations (e.g., in the DDR6 specification) can remain two-UI operations regardless of whether the module is configured for four ranks or eight ranks, preserving full command bus throughput and preventing the bandwidth degradation characteristic of Case 2.

Various aspects provided herein can include a pass-through operating mode for the buffer (e.g., RCD). In certain memory architectures, such as those employing 3D Stacked DRAM where the DRAM base die contains internal rank-selection logic, it may be desirable for the RCD to forward DCS and DCA signals to QCS and QCA without performing internal decoding. Such an RCD can support a pass-through mode, selectable via a mode control signal, in which received frontside signals are forwarded directly to the backside output interface. Even in pass-through mode, the RCD may continue to perform parity checking on incoming CA bus signals and blocks commands from reaching the DRAM if a parity error is detected, preserving signal integrity protection. This mode can extend the applicability of the buffer design across both standard planar RDIMM and 3DS DRAM architectures.

Various aspects described herein provides a virtual host test mode for validating rank-selection encoding and decoding logic. Validating high-speed memory interfaces typically requires full-speed host systems or expensive automated test equipment. In described virtual host mode, the RCD can accept command inputs via a low-speed sideband interface, which may be separate from the main DCS and DCA signal paths, and internally can generate encoded CS signal patterns using the DDR encoding scheme, driving these patterns on the QCS and QCA output interface at full operational speed. The QCS and QCA outputs can be connected to a downstream DRAM device or to a second RCD operating in its normal input mode, enabling daisy-chain validation of the encoding and decoding scheme at full speed without requiring a fully operational host memory controller.

Various aspects described herein can address mode initialization and reset protocol requirements arising from the coexistence of multiple operating modes. The RCD must exhibit a well-defined default operating mode following power-on to ensure unambiguous initial communication between the memory controller and the RCD before mode registers are programmed. Once the initial handshake is complete, mode registers within the RCD can be written by the memory controller to select among the available operating modes. A standard RCD reset does not revert the RCD to its default mode, as resets occur during normal operation and should not disturb the programmed configuration. A dedicated reset sequence, such as asserting the reset signal while holding both DCS0 and DCS1 at a logic high state, can provide an unambiguous mechanism for restoring the RCD to its default power-on configuration when explicitly required.

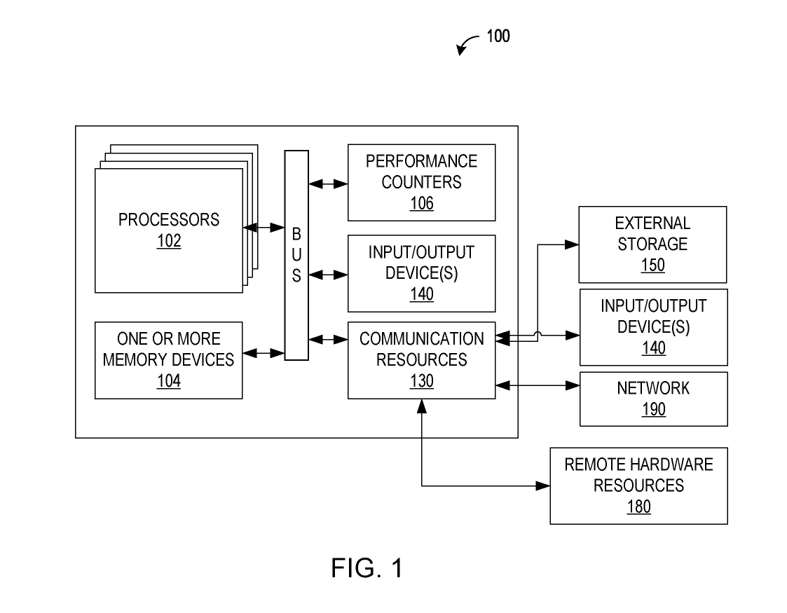

FIG. 1 illustrates a block diagram of an example computing system 100 in accordance with various aspects described herein. The computing system 100 typically includes a system of interconnected hardware and software resources configured to execute instructions, process data, and manage the allocation of computational capabilities. The computing system 100 may be a server, a workstation, a cluster of servers, a data center, or a cloud computing infrastructure. External storage 150, network 190, external input and output devices 140, and remote hardware resources 180 connect to the hardware resources via the communication resources 130 and input and output devices 140.

The computing system 100 generally includes one or more processors 102, one or more memory devices 104, a bus, communication resources 130, and one or more input/output devices 140. The processors 102 represent the computational core of the computing system 100 and each processor among the processors 102 integrates a cache hierarchy and a memory controller interface through which the processor 102 initiates memory transactions directed to the one or more memory devices 104.

The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor among the processors 102 communicates with the one or more memory devices 104 through a memory controller that manages command scheduling, address mapping, rank selection, refresh management, and coordination of data transfers, incorporating timing control logic that enforces the temporal constraints imposed by the memory interface specification.

In some examples, the one or more processors 102 may execute instructions (e.g., non-transitory computer-readable instructions). Instructions may include software, program code, application(s), applet(s), an app(s), firmware, microcode, machine code, and/or other executable code for causing at least any one of the processors 102 to perform a method. The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In high-performance configurations, the one or more memory devices 104 may include high bandwidth memory or double data rate synchronous dynamic random access memory. The one or more memory devices 104 can be organized into physical banks or modules, such as DIMMs. Each DIMM may be configured as an RDIMM including an RCD and a plurality of DRAM devices organized into one or more ranks, where the RCD is positioned electrically between the memory controller and the DRAM devices and buffers command, address, and clock signals as described herein. Within the context of the computing system 100, the one or more memory devices 104 may be distributed across different memory controllers associated with specific processors or specific non-uniform memory access nodes.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory.

The processors 102 and the one or more memory devices 104 communicate via a bus or an interconnect system. The bus represented in FIG. 1 generally illustrates the data pathways within the computing system 100. In practice, this bus may include a complex web of point-to-point interconnects, such as the ultra path interconnect or the quickpath interconnect. These interconnects facilitate high-speed data transfer between different processor sockets and between processors and memory controllers. The interconnects possess finite bandwidth and impose latency penalties on data traversing them. When a processor core attempts to access a memory address located in a remote portion of the one or more memory devices 104, the request traverses this interconnect, resulting in remote access latency. The memory interface between the memory controller and each RDIMM carries multiple physical signal groups: unidirectional command and address signals on the CA bus, chip select signals (CS) including the frontside paths DCS0 and DCS1, differential clock signals (CK/CK#), and bidirectional data signals (DQ) and data strobe signals (DQS/DQS#) that carry read and write data between the memory controller and the DRAM devices.

In a typical memory access, a processor among the processors 102 issues a memory request that the memory controller translates into a sequence of DRAM commands transmitted via the CA bus and CS signal paths to the RDIMM; the RCD decodes the target rank from the encoded CS signals and forwards the command to the appropriate rank via the back interface, after which the addressed DRAM devices complete the data transfer on the DQ bus. Aspects described herein can apply specifically to the signaling protocol governing the DCS0 and DCS1 chip select paths between the memory controller and the RCD, and in particular to the encoding of rank-selection bits within those paths across consecutive time unit intervals.

The memory interface between the memory controller and the one or more memory devices 104 operates at multi-gigahertz frequencies with timing margins measured in tens of picoseconds, requiring precise signal integrity management at every stage of the signal path; registered DIMMs are the standard module form factor in server and datacenter deployments of the computing system 100 where module capacity, signal integrity across densely populated channels, and reliability under sustained workloads are primary design requirements.

The communication resources 130 enable the computing system 100 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. The communication resources 130 connect the computing system 100 to a network 190. The network 190 may be a local area network, a wide area network, the internet, or a dedicated storage area network. Through the network 190, the computing system 100 may access remote hardware resources 180 and external storage 150. For example, the communication resources 130 may include wired communication components, cellular communication components, Wi-Fi components, and other communication components.

The input/output devices 140 associated with the computing system 100 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 11 also illustrates input/output devices 140 external to the computing system 100, which may represent peripherals connected via the communication resources 130 or the network 190, providing flexibility in system configuration.

The external storage 150 represents persistent data storage repositories located outside the immediate physical chassis of the computing system 100. The external storage 150 may include storage area networks, network-attached storage systems, or cloud-based storage services. The external storage 150 may store application data and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the computing system 100 may function as one physical node in a larger cluster, with the remote hardware resources 180 constituting the other physical nodes. The remote hardware resources 180 may possess similar or different configurations compared to the computing system 100. The ability to communicate with the remote hardware resources 180 enables distributed processing, where a single large task is decomposed into smaller sub-tasks executed in parallel across multiple machines.

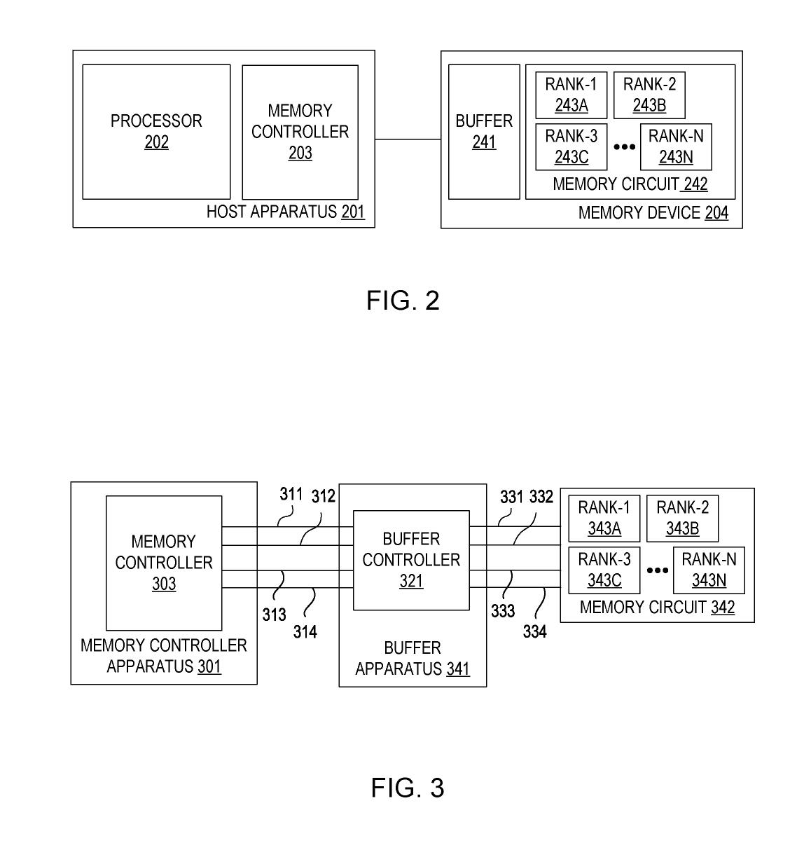

FIG. 2 illustrates a block diagram of an example memory controller and registered DIMM interface in accordance with aspects described herein. The system depicted in FIG. 2 includes a host apparatus 201 (e.g., a processor of the processors 102) and a memory device 204 (e.g., one of the memory devices 104). The host apparatus 201 may include a processor 202 and a memory controller 203. The memory device 204 may include a buffer 241 and a memory circuit 242. The memory circuit 242 includes a plurality of ranks, e.g., rank-1243A, rank-2243B, rank-3243C, through rank-N 243N, organized within the memory device 204. The memory controller 203 may include a command queue that accumulates and orders pending memory transactions, address mapping logic that translates system physical addresses to DRAM row, column, bank, bank group, and rank coordinates, timing control logic that enforces the temporal constraints of the memory interface specification, signal drivers for the command/address (CA) bus and CS signal paths, a clock generation and distribution circuit for the differential clock (CK/CK#) outputs, and data transceivers for the bidirectional data (DQ) and data strobe (DQS/DQS#) signal paths.

The processor 202 may represent the computational core of the host apparatus 201 and initiates memory transactions by issuing requests to the memory controller 203. The processor 202 may be any of the processing unit types described with respect to FIG. 1, including a CPU, GPU, or other processing unit. The processor 202 and the memory controller 203 can communicate via a high-speed internal bus or point-to-point interconnect within the host apparatus 201. In some implementations, the memory controller 203 is integrated within the same die as the processor 202; in other implementations, the memory controller 203 resides in a separate die or package coupled to the processor 202 via a chip-to-chip interconnect. In either case, the memory controller 203 serves as the sole host-side originator of commands, addresses, and data presented on the front interface toward the memory device 204.

The memory controller 203 communicates with the memory device 204 via a front interface including multiple physical signal groups. The chip select signals on the front interface, e.g., DCS0 and DCS1, can be driven unidirectionally from the memory controller 203 to the buffer 241 and carry command latch and rank-selection information encoded across consecutive time unit intervals as described herein. The frontside command/address bus (DCA) can be driven unidirectionally from the memory controller 203 to the buffer 241 and carries operation codes identifying the type of DRAM command being issued—such as ACTIVATE, READ, WRITE, PRECHARGE, or REFRESH—as well as the row address, column address, bank address, and bank group address fields associated with the operation. The frontside differential clock (DCK/DCK#) may be driven from the memory controller 203 to the buffer 241 and provide the reference clock against which all command, address, and chip select signals are sampled. The DCS0 and DCS1 signals together can be carried by first signal path and second signal path of the interface.

The buffer 241 may be a register device, specifically an RCD, which may be coupled electrically between the front interface driven by the memory controller 203 and the back interface driving the memory circuit 242. The buffer 241 receives the DCS0, DCS1, DCA, and DCK signals on its input interface from the memory controller 203. The buffer 241 may perform signal buffering and re-timing, regenerating the received signals to restore signal integrity margins that would otherwise degrade across the capacitive load of the memory circuit 242. The buffer 241 may decode the rank-selection information embedded in the DCS0 and DCS1 signals to determine which among the ranks 243A through 243N is the target of the current memory operation, and generates the appropriate backside chip select (QCS) output signal to activate the identified rank. The buffer 241 may also regenerate the command/address and clock signals for re-driving to the memory circuit 242. The buffer 241 can correspond to a register device, and the input interface of the buffer 241 can correspond to the input interface of the apparatus.

The buffer 241 drives the memory circuit 242 via a back interface including the backside chip select signals (QCS), the backside command/address bus (QCA), and the backside differential clock (QCK/QCK#). The QCS signals can be generated by the buffer 241 based on the decoded rank-selection configuration. For example, the buffer 241 may assert the QCS signal corresponding to the target rank and deassert the QCS signals corresponding to all non-target ranks. Each rank among the ranks 243A through 243N may have a dedicated QCS signal line on the back interface; accordingly, the number of QCS signal lines driven by the buffer 241 may equal the number of ranks populated in the memory circuit 242. The QCA bus can carry the regenerated command and address information from the buffer 241 to the memory circuit 242, and the QCK/QCK# differential clock can provide the timing reference for all backside signal sampling. The output interface of the buffer 241, including the QCS, QCA, and QCK outputs, may correspond to an output interface as described herein.

The memory circuit 242 within the memory device 204 may include a plurality of DRAM ranks organized as rank-1243A, rank-2 243B, rank-3243C, and up to rank-N 243N, N being an integer. Each rank among the ranks 243A through 243N can include a set of DRAM devices that are accessed simultaneously to fill the full width of the data bus. Each rank can share the QCA and QCK backside signals with all other ranks but may be individually addressable via its dedicated QCS backside signal line. When the buffer 241 asserts the QCS signal corresponding to a target rank, only the DRAM devices within that rank respond to the command presented on the QCA bus; all other ranks remain quiescent. The data signals (DQ) and data strobe signals (DQS/DQS#) may be routed between the memory controller 203 and the memory circuit 242 to carry read and write data, a data path as described herein, with the memory controller 203 transmitting data signals via the data path in coordination with the rank-selection configuration determined from the DCS0 and DCS1 encoded signals.

The memory device 204 may further include a power management integrated circuit (PMIC) that regulates the supply voltages required by the buffer 241 and the memory circuit 242, including the core voltage for DRAM cell arrays, the I/O voltage for signal interface circuitry, and the reference voltages required for signal termination. The buffer 241 may electrically isolate the memory controller 203 from the aggregate capacitive load presented by the DRAM devices of the memory circuit 242 across all ranks 243A through 243N..

FIG. 3 illustrates a block diagram depicting a memory controller apparatus 301 and a buffer apparatus 341, which together may form a complementary encoder-decoder pair for rank-selection signaling as described herein. The memory controller apparatus 301 includes a memory controller 303, which serves as the signal encoding component. The buffer apparatus 341 includes a buffer controller 321, which serves as the signal decoding and re-driving component. The memory controller apparatus 301 and the buffer apparatus 341 may communicate via interface 311, 312, 313, and 314, which may correspond to the front interface as described herein. The buffer apparatus 341 further communicates with a memory circuit 342 via output interface 331, 332, 333, and 334, which may correspond to the back interface. The memory circuit 342 includes a plurality of ranks including rank-1 343A, rank-2343B, rank-3343C, and up to rank-N 343N. The relationship between the memory controller apparatus 301 and the buffer apparatus 341 in FIG. 3 corresponds to the relationship between the memory controller 203 and the buffer 241 shown in FIG. 2, with FIG. 3 providing additional detail on the signal paths and the internal controller components.

The memory controller apparatus 301 includes an interface including a first signal path 311 and a second signal path 312 coupled to the buffer apparatus 341. The first signal path 311 may correspond to the DCS0 signal path described herein, and the second signal path 312 may correspond to the DCS1 signal path. The first signal path 311 and the second signal path 312 may form the interface of the memory controller apparatus 301, wherein the interface can be, through further intermediate components, coupled to a memory device. The memory device may include the buffer apparatus 341 interposed between the memory controller apparatus 301 and the memory circuit 342.

Correspondingly, the buffer apparatus 341 includes an input interface that includes a first signal path receiving the signal driven on path 311 by the memory controller 303 and a second signal path receiving the signal driven on path 312. The input interface is coupled to the memory controller 303 via the frontside signal paths. Signals 313 and 314 represent additional front interface signals, including the frontside command/address bus (DCA) and the frontside differential clock (DCK/DCK#), which may also be received at the input interface of the buffer apparatus 341. The signal flow across the front interface may be unidirectional, such that the memory controller 303 drives signals 311 and 312 from the memory controller apparatus 301 toward the buffer apparatus 341.

The memory controller 303 within the memory controller apparatus 301 may be configured to determine a memory selection configuration represented by a plurality of bits. The memory selection configuration identifies which specific rank among rank-1343A through rank-N 343N is the target of a pending memory operation. For a memory circuit 342 populated with eight ranks, the memory selection configuration can be represented by three bits. The memory controller 303 determines the memory selection configuration by resolving a system-level memory request, e.g., issued by the processor 202 of FIG. 2, to a specific rank address through address mapping logic.

Once the memory controller 303 has determined the memory selection configuration, the memory controller 303 may drive the first signal path 311, within a first time unit interval (UI0), to a state indicating that a memory selection operation associated with the plurality of bits is being initiated. This state on the first signal path 311 within UI0 may function as the command latch indication, notifying the buffer controller 321 that a valid command and associated rank-selection encoding are present on the interface signals. Correspondingly, the buffer controller 321, within the same first time unit interval UI0, can receive via the first signal path of the input interface the state signal on path 311 and recognize the state as indicating that a memory selection operation is present. The buffer controller 321 can capture this command latch indication and prepare to receive and accumulate the rank-selection bits that (may) follow.

The memory controller 303 is further configured to drive the first signal path 311, within a second time unit interval (UI1) consecutive to the first time unit interval UI0, to an encoded state indicating a first bit of the plurality of bits. This may represent an operation of the first signal path 311, whereas in conventional DDR6 operation the first signal path would remain in its command-latch state through both UI0 and UI1 without conveying additional information, the memory controller 303 may transition the first signal path 311 at the boundary between UI0 and UI1 to a logic state encoding the first rank-selection bit. The first signal path 311 can thereby perform two distinct functions across two consecutive UIs. Illustratively, in UI0, the first signal path 311 may carry the command latch indication, and in UI1, the first signal path 311 may carry an encoded rank-selection bit.

Correspondingly, the buffer controller 321 may be configured to receive, via the first signal path of the input interface, within the second time unit interval UI1, the first bit of the plurality of bits. The buffer controller 321 can sample the input corresponding to signal path 311 twice, e.g., once at the edge defining UI0 to capture the command latch indication, and once at the edge defining UI1 to capture the encoded first rank-selection bit, extracting distinct and independent pieces of information from the same physical input path at successive sampling instances.

The memory controller 303 may further be configured to drive the second signal path 312 to an encoded state indicating a second bit of the plurality of bits within the first time unit interval UI0 or the second time unit interval UI1. The second signal path 312 can operate in DDR mode, such that the memory controller 303 drives one encoded bit on the second signal path 312 at the clock edge defining UI0 and another encoded bit at the clock edge defining UI1. In an embodiment, the second signal path 312 carries the second rank-selection bit in UI0 and the third rank-selection bit in UI1 for a three-bit encoding scheme. The second signal path 312 can therefore deliver encoded rank-selection bits on both UI0 and UI1, contributing two bits of rank-selection information within the standard two-UI command window.

Correspondingly, the buffer controller 321 may receive, via the second signal path of the input interface, within the first time unit interval UI0 or the second time unit interval UI1, the second bit of the plurality of bits. The buffer controller 321 may sample the input corresponding to signal path 312 at both the rising and falling clock edges within the two-UI window, capturing the encoded bit values presented on the second signal path 312 at each respective edge.

Upon receiving all bits of the plurality from the input interface, the buffer controller 321 can determine the memory selection configuration based on the plurality of bits including the first bit received from the first signal path 311 in UI1 and the second bit received from the second signal path 312 within UI0 or UI1. The memory controller 303 can encode the complete memory selection configuration by distributing the plurality of bits across the first signal path 311 and the second signal path 312, with the bits timed to arrive at the buffer apparatus 341 input interface within two consecutive UIs. The buffer controller 321 may combine the received bits to form a binary address code that uniquely identifies the target rank, and maps this bit pattern to the corresponding rank among rank-1 343A through rank-N 343N. In an example, the mapping may be implemented by the buffer controller 321 as a lookup table, a decoder circuit, or combinatorial logic, for example, a three-bit pattern of binary value 011 may map to rank-3343C. The determination of the memory selection configuration by the buffer controller 321 may complete the decoding cycle, enabling the buffer controller 321 to proceed immediately with asserting the appropriate backside output signals toward the memory circuit 342 without waiting for any further input.

The buffer apparatus 341 further includes an output interface coupled to the memory circuit 342, with the output interface carrying signals 331, 332, 333, and 334. The buffer controller 321 acts as an RCD buffer between the input interface receiving signals 311 and 312 and the output interface driving signals 331 through 334 to the memory circuit 342, providing signal buffering, re-timing, and rank-selection decoding. Signal 331 may represent the backside chip select output (QCS), which the buffer controller 321 asserts selectively to the rank identified by the decoded memory selection configuration. Signal 332 may represent the backside command/address bus (QCA), carrying the regenerated command and address information to the memory circuit 342. Signal 333 may represent the backside differential clock (QCK/QCK#), providing the timing reference for all backside signal sampling. Signal 334 may represent additional backside control signals as required by the memory circuit 342.

The buffer controller 321 may assert the QCS output 331 corresponding to the identified target rank, for example, asserting the QCS line to rank-3343C, while simultaneously deasserting the QCS lines corresponding to all non-selected ranks including rank-1 343A, rank-2 343B, and rank-N 343N, so that only the target rank responds to the command presented on QCA 332.

The buffer controller 321 may provide electrical isolation between the front interface driven by the memory controller 303 and the back interface driving the memory circuit 342. The aggregate capacitive load of the DRAM devices including rank-1343A through rank-N 343N across the memory circuit 342 would, if driven directly from the memory controller 303, impose a load exceeding the drive capability of the memory controller 303 output drivers at DDR6 operating frequencies. The buffer controller 321 may resolve this by accepting the signals 311 and 312 at its input interface, presenting a designated low-capacitance load to the memory controller 303, and independently driving the output interface signals 331 through 334 with the drive strength required to maintain valid signal levels at each of the ranks 343A through 343N.

Each rank among 343A through 343N may include a set of DRAM devices that are accessed simultaneously to fill the full width of the data bus. All ranks within the memory circuit 342 may share the QCA bus 332 and the QCK signal 333 from the output interface of the buffer apparatus 341, but each rank may have a dedicated QCS line within signal 331, driven individually by the buffer controller 321 based on the decoded memory selection configuration. In a memory circuit 342 configured as an eight-rank memory, N equals eight and the ranks 343A through 343N are rank-1 through rank-8; the buffer controller 321 can assert one of eight individual QCS lines per memory operation. The ranks 343A through 343N may collectively represent the target space from which the memory controller 303 selects by encoding the memory selection configuration onto signal paths 311 and 312.

In an example, the memory controller 303 may incorporate driver circuitry for the first signal path 311 that is capable of transitioning the first signal path 311 between distinct logic states at both the rising edge and the falling edge of the clock signal on path 313. This driver circuitry may include a push-pull output stage or a current-mode driver capable of settling to a valid logic level within the UI timing window defined by the DDR6 specification. The driver circuitry for the first signal path 311 may be controlled by encoding logic within the memory controller 303 that, for each memory operation, loads the command latch state for UI0 and the first rank-selection bit for UI1, and sequences the driver circuitry to output these values at the respective clock edges. The driver circuitry for the second signal path 312 may similarly be configured to output the second and third rank-selection bits at UI0 and UI1 respectively. The memory controller 303 may coordinate the operation of the driver circuitry for signal paths 311 and 312 such that all bits of the memory selection configuration are serialized onto the two signal paths within the two-UI window of a single clock cycle.

The buffer controller 321 may incorporate input sampling circuitry for the input paths corresponding to signals 311 and 312 that captures the logic state of each input at both the rising and falling edges of the clock signal delivered on path 314. For example, the input sampling circuitry for the first signal path input samples the logic state at the rising edge (UI0) to capture the command latch indication and at the falling edge (UI1) to capture the first rank-selection bit. The input sampling circuitry for the second signal path input samples the logic state at the rising edge (UI0) to capture the second rank-selection bit and at the falling edge (UI1) to capture a third rank-selection bit when the plurality of bits includes three bits. The captured bit values may be held in registers within the buffer controller 321 and presented to rank-decoding logic of the buffer controller 321 that determines the memory selection configuration. In an example, the rank-decoding logic includes a three-to-eight decoder that maps each of the eight possible three-bit combinations to one of the eight output select lines of signal 331, each output select line corresponding to one of rank-1343A through rank-N 343N.

The memory controller apparatus 301 and the buffer apparatus 341 may be coupled by the front interface signals 311 through 314 in a topology wherein the memory controller apparatus 301 may be the sole source of rank-selection encoding and the buffer apparatus 341 is the sole decoder of that encoding before commands and addresses are forwarded to the memory circuit 342. This unidirectional encoding-decoding relationship may facilitate that the buffer apparatus 341 always activates only the rank identified by the memory controller 303, maintaining deterministic rank selection across all operating conditions. In configurations where the memory circuit 342 is organized with fewer than eight ranks, such as a four-rank configuration, the same front interface signals 311 and 312 and the same buffer apparatus 341 input interface can be used, with the memory controller 303 encoding only two rank-selection bits and the buffer controller 321 decoding a two-bit memory selection configuration.

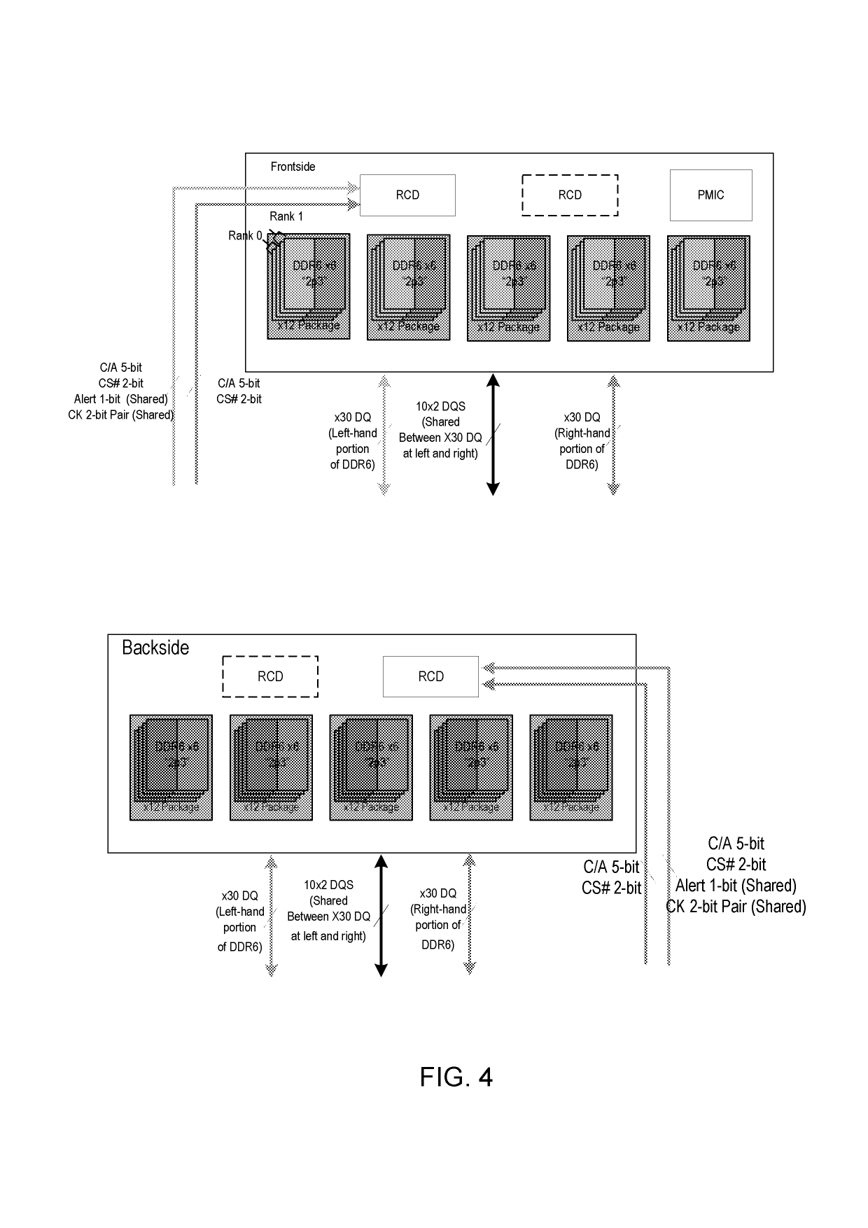

FIG. 4 illustrates a physical layout diagram of an example memory module in accordance with aspects described herein. Illustratively, the memory module may include the buffer controller 321 (as one of the RCDs, e.g., a primary RCD) and the memory circuit 342, which may be coupled to the memory controller apparatus 301. The memory module has been illustrated as a DDR6 RDIMM module. The DDR6 RDIMM can include a single printed circuit board (PCB) substrate populated with DRAM devices, RCDs, and a PMIC on both of its opposing surfaces as depicted herein. The upper portion of FIG. 4 depicts the frontside surface of the PCB substrate, and the lower portion of FIG. 4 depicts the backside surface of the same PCB substrate; these two diagrams together represent one physical RDIMM module.

The frontside surface may contain one primary RCD shown with a solid-border hatching, one secondary RCD shown with a dashed border, and one PMIC. The backside surface of the same substrate contains one primary RCD shown with a solid border and one secondary RCD shown with a dashed border. The frontside surface further may carry, for example, five DRAM devices, each identified as a DDR6 ×6 device designated "2p3" and packaged in an ×12 package configuration, with the leftmost DRAM device labeled as belonging to Rank 0 and Rank 1 as annotated in FIG. 4. The backside surface of the same substrate likewise carries five DRAM devices of the same DDR6 ×6 "2p3" ×12 package type. Populating both surfaces of the PCB substrate with DRAM devices is a primary mechanism by which high rank counts are achieved on a single RDIMM module. The ranks on the frontside surface and the ranks on the backside surface together include the total rank population of the module, corresponding to the ranks 343A through 343N of the memory circuit 342 described with respect to FIG. 3. The PMIC mounted on the frontside surface may provide regulated supply voltages to the RCDs and DRAM devices across both surfaces of the substrate, as described with respect to FIG. 2.

The frontside surface of the PCB substrate may receive some or all of the following signal groups from the memory controller at the left-hand edge of the DIMM connector: a Command/Address bus of five bits (C/A 5-bit), a Chip Select bus of two bits (CS# 2-bit) corresponding to the DCS0 and DCS1 signal paths described herein, an Alert signal of one bit shared across the module (Alert 1-bit, Shared), and a differential clock pair of two bits shared across the module (CK 2-bit Pair, Shared). The primary RCD on the frontside surface receives a C/A 5-bit and CS# 2-bit signal group routed from the DIMM connector and re-drives corresponding backside signals toward the DRAM devices on the frontside surface.

The data signals on the frontside surface may include three groups: a first group of ×30 DQ bidirectional lines forming the left-hand portion of the DDR6 data bus, a second group of ×30 DQ bidirectional lines forming the right-hand portion of the DDR6 data bus, and a shared 10×2 DQS strobe group positioned between the left-hand and right-hand ×30 DQ groups and shared between both DQ portions. The backside surface of the same substrate receives its own C/A 5-bit and CS# 2-bit signal groups routed from the right-hand edge of the same DIMM connector, along with the Alert 1-bit (Shared) and CK 2-bit Pair (Shared) signals that are distributed across both surfaces of the substrate via the shared connector. The backside surface carries a correspondingly organized set of data signal groups: a ×30 DQ group forming the left-hand portion, a ×30 DQ group forming the right-hand portion, and a shared 10×2 DQS group between them.

In an example, the memory controller 303 may be configured such that the first time unit interval and the second time unit interval correspond to opposite edges of the clock signal delivered to the buffer apparatus 341 via the CK 2-bit Pair (Shared) distributed across both surfaces of the PCB substrate of FIG. 4. The memory controller 303 drives the first signal path 311, corresponding to one bit of the CS# 2-bit signal group at the DIMM connector, with a state established at the first clock edge defining UI0, and drives the first signal path 311 again with a potentially different encoded state established at the opposite clock edge defining UI1. The memory controller 303 similarly drives the second signal path 312, corresponding to the other bit of the CS# 2-bit signal group, with transitions at the same pair of opposite clock edges.

The buffer controller 321 within the primary RCD on the frontside surface of FIG. 4 may be correspondingly configured such that the first and second time unit intervals correspond to the same opposite clock edges received at the buffer apparatus 341 input interface, with the buffer controller 321 sampling the inputs corresponding to signal paths 311 and 312 at the rising edge defining UI0 and at the falling edge defining UI1. By sampling at both edges rather than at a single edge, the buffer controller 321 extracts independent encoded information from each clock edge within a single clock cycle, which is the defining characteristic of DDR reception as contrasted with SDR reception in which only a single edge is sampled.

In an example, the first time unit interval UI0 corresponds to the rising edge of the clock signal and the second time unit interval UI1 corresponds to the falling edge of the clock signal. The memory controller 303 establishes the state of the first signal path 311 at the rising clock edge to carry the command latch indication as described herein, and establishes the state of the first signal path 311 at the falling clock edge to carry the encoded first rank-selection bit. The memory controller 303 may establish the state of the second signal path 312 at the rising clock edge to carry the encoded second rank-selection bit and at the falling clock edge to carry a third encoded bit. The buffer controller 321 within the primary RCD on each surface of the PCB substrate is synchronized to the CK signal from the DIMM connector, and samples the input corresponding to the first signal path 311 at the rising edge to capture the command latch indication and at the falling edge to capture the first rank-selection bit, and samples the input corresponding to the second signal path 312 at the rising and falling edges to capture the second and third rank-selection bits respectively. Because each RCD receives its own independent CK signal from the DIMM connector, the DDR edge definitions for UI0 and UI1 are established for each RCD, ensuring synchronized sampling within each RCD’s own pseudo-channel partition across the ranks of the memory circuit 342.

The buffer controller 321 may be correspondingly configured such that the first and second time unit intervals correspond to the same opposite clock edges received at the buffer apparatus 341 input interface, with the buffer controller 321 sampling the inputs corresponding to signal paths 311 and 312 at the rising edge defining UI0 and at the falling edge defining UI1. By sampling at both edges rather than at a single edge, the buffer controller 321 may extract independent encoded information from each clock edge within a single clock cycle, which may be the characteristic of DDR reception as contrasted with SDR reception in which only a single edge is sampled.

In an example, the memory controller 303 drives the second signal path 312—corresponding to one of the two bits of the CS# 2-bit signal group at the DIMM connector, i.e. in DDR mode, delivering encoded bits on both the rising and falling edges of the clock signal within the first and second time unit intervals. Specifically, the memory controller 303 drives a first encoded bit value onto the second signal path 312 at the rising edge (UI0) and drives a second encoded bit value onto the second signal path 312 at the falling edge (UI1), such that the second signal path 312 carries two encoded rank-selection bits within a single clock cycle without requiring any additional time slots beyond the standard two-UI command window. The buffer controller 321 within the primary RCD on the relevant surface of the PCB substrate is correspondingly configured to receive encoded bits from the second signal path input on both edges of the clock signal within the first and second time unit intervals. The buffer controller 321 samples the input corresponding to the second signal path 312 at the rising edge to capture the first encoded bit value and at the falling edge to capture the second encoded bit value, using DDR reception circuitry that independently latches the input state at each clock edge. The two bits captured from the second signal path 312 across UI0 and UI1, combined with the one bit captured from the first signal path 311 in UI1 as described with respect to FIG. 3, provide all bits required for rank-selection decoding within the two-UI window of a single clock cycle.

In an example, the CS# 2-bit signal group at the DIMM connector carries both DCS0 and DCS1—corresponding to the first signal path 311 and the second signal path 312 respectively—as a two-wire chip select bus. In the DDR encoded mode described herein, both DCS0 and DCS1 operate in DDR mode across the two-UI window of a command cycle. The CS, C/A, CK, and Alert signals are routed independently to each RCD from the DIMM connector; no signals are shared between the two RCDs on the module, nor across the two separate 2x30 channel groups on the frontside and backside. The “Shared” designation in FIG. 4 refers to intra-die signal sharing within each individual DDR DRAM package, wherein each DRM device organized in the 2p3 configuration, e.g., two-pseudo-channels of 3xDQ within a single package, shares CK, Alert, and DQS signals between its two internal pseudo-channels as part of the internal die architecture. The Alert 1-bit signal provides a return path from each RCD independently to the memory controller for reporting error conditions including the CA parity errors monitored by the buffer controller 321. The collective operation of the CS# 2-bit, CK 2-bit Pair, C/A 5-bit, and Alert 1-bit signal groups independently routed to each RCD at the DIMM connector of FIG. 4 constitutes the complete command control interface through which the memory controller 303 encodes and each buffer controller 321 decodes the memory selection configuration using the DDR chip select encoding scheme, with the encoding and decoding operating consistently across the DRAM devices and RCDs mounted on both surfaces of the PCB substrate.

In an example, each one or more RCDs of at least two RCDs on the DIMM operates fully independently of the other with no shared signals between them. For example, one or more frontside RCDs receive their own dedicated C/A 5-bit, CS# 2-bit, and CK signal groups routed independently from the DIMM connector, and control the full 2×30 DQ pseudo-channel complement on the frontside surface. One or more backside RCDs likewise receive their own independent C/A 5-bit, CS# 2-bit, and CK signal groups from the DIMM connector, and control the full 2×30 DQ pseudo-channel complement on the backside surface. Each RCD constitutes an independent instance of the buffer apparatus 341 as described herein, independently receiving encoded signals on its own dedicated first signal path 311 and second signal path 312, independently executing the rank-decoding operation via its own buffer controller 321, and independently driving its own output interface toward the DRAM devices on its respective surface. The 2×30 DQ pseudo-channels on the frontside surface and the 2×30 DQ pseudo-channels on the backside surface may thereby be fully independent of one another, with each surface's RCD solely responsible for rank selection and command forwarding within its own pseudo-channel partition..

The alert signal (Alert 1-bit, Shared) on the front interface may provide a return path from the RCD to the memory controller for reporting error conditions, including the CA parity errors that the buffer controller 321 monitors as described above. The collective operation of the CS# 2-bit, CK 2-bit Pair, C/A 5-bit, and Alert 1-bit signal groups on the front interface of FIG. 4 constitutes the complete command control interface through which the memory controller 303 encodes and the buffer controller 321 decodes the memory selection configuration using the DDR chip select encoding scheme of the disclosed technology.

In an example, the plurality of bits determined by the memory controller 303 and conveyed across the first signal path 311 and the second signal path 312 includes three bits. The memory controller 303 drives the first signal path 311 within the second time unit interval UI1 to an encoded state indicating a first bit of the plurality, cs0. The memory controller 303 drives the second signal path 312 to an encoded state indicating a second bit of the plurality, cs1, within the first time unit interval UI0, and drives the second signal path 312 to an encoded state indicating a third bit of the plurality, cs2, within the second time unit interval UI1.

Accordingly, across the two-UI window, the first signal path 311 contributes one rank-selection bit in UI1 and the second signal path 312 contributes one rank-selection bit in UI0 and one rank-selection bit in UI1, for a total of three rank-selection bits delivered within two consecutive time unit intervals. Correspondingly, the buffer controller 321 may be configured to receive, via the first signal path of the input interface, the first bit cs0 within the second time unit interval UI1, and to receive, via the second signal path of the input interface, the second bit cs1 within one of the first or second time unit interval and the third bit cs2 within the other of the first or second time unit interval, specifically, cs1 from UI0 and cs2 from UI1 of the second signal path input. The buffer controller 321 thereby accumulates all three bits of the memory selection configuration across its two input paths within the standard two-UI command window.

The three-bit memory selection configuration can enable the memory controller 303 to represent a selection of one of more than four ranks of the memory circuit 342. When the memory circuit 342 is configured with eight ranks, that is, when N=8, three bits are necessary and sufficient to uniquely identify any one of the eight ranks. The three-bit encoding therefore extends the rank-selection capability of the two-CS-pin front interface beyond the four-rank limit achievable with two bits, doubling the maximum addressable rank count from four to eight without adding any physical signal paths to the interface. The three bits cs0, cs1, cs2 collectively form a binary rank address that the buffer controller 321 maps to the corresponding rank among rank-1 343A through rank-N 343N, enabling eight-rank configurations of the memory circuit 342 to be fully addressed via the same two-signal-path frontside.

In an example, the memory controller 303 is configured to drive the first signal path 311 and the second signal path 312 to collectively convey all bits of the plurality within two consecutive time unit intervals, regardless of whether the plurality includes two bits for four-rank selection or three bits for eight-rank selection. The memory controller 303 may encode the complete memory selection configuration such that all bits are present at the input interface of the buffer apparatus 341 by the end of UI1, the conclusion of the first clock cycle. As a result, the buffer controller 321 can receive all required bits within the two-UI window and is able to complete determination of the memory selection configuration without waiting for any bit to arrive in a third time unit interval UI2.

In an example, the buffer controller 321 processes the three bits received from the input interface of the buffer apparatus 341 to uniquely identify the target rank within the memory circuit 342 and generate the corresponding backside output. The buffer controller 321 can combine the first bit cs0 received from the first signal path input in UI1, the second bit cs1 received from the second signal path input in UI0, and the third bit cs2 received from the second signal path input in UI1, forming a three-bit binary pattern. The buffer controller 321 applies rank-decoding logic, which may be implemented as a three-to-eight decoder, a combinatorial logic network, or a lookup table, to map each possible three-bit pattern to one of the eight rank output select lines within signal 331.

As a concrete example of this mapping: a bit pattern of binary 000 selects rank-1343A; a bit pattern of binary 001 selects rank-2343B; a bit pattern of binary 010 selects rank-3343C; a bit pattern of binary 011 selects rank-4; a bit pattern of binary 100 selects rank-5; a bit pattern of binary 101 selects rank-6; a bit pattern of binary 110 selects rank-7; and a bit pattern of binary 111 selects rank-N 343N. Upon completing the rank-decoding operation, the buffer controller 321 may assert the QCS output line on signal 331 corresponding to the identified rank while simultaneously deasserting the QCS output lines corresponding to all non-selected ranks, ensuring that only the single target rank among rank-1 343A through rank-N 343N responds to the command and address information presented on the QCA output 332 of the buffer apparatus 341.

In an example, the memory controller 303 may drive the encoded signals on the first signal path 311 and the second signal path 312 toward the input interface of the buffer apparatus 341. The buffer apparatus 341 buffers, decodes, and re-drives the received signals via the output interface signals 331 through 334 to the memory circuit 342, and the memory circuit 342 may respond to the backside QCS signal 331 asserted by the buffer controller 321 for the rank identified by the decoded memory selection configuration. The buffer apparatus 341 can occupy an intermediate position in the signal chain between the memory controller apparatus 301 and the memory circuit 342.

In an example, the memory controller 303 is further configured to transmit a mode control signal to enable a pass-through mode in the buffer apparatus 341. The mode control signal may be a control communication directed from the memory controller 303 to the buffer apparatus 341 and may be implemented as a mode register write command delivered via a sideband management interface, such as an I²C or I3C serial bus, that writes to a configuration register within the buffer controller 321. Additionally, or alternatively, the mode control signal may be a dedicated command sequence presented on the first signal path 311 and the second signal path 312 that the buffer controller 321 can recognize as a mode-transition instruction.

Correspondingly, the buffer controller 321 may be further configured to receive the mode control signal via the sideband interface or command interface and to enable pass-through mode within the buffer apparatus 341 in response to the received mode control signal. Upon enabling pass-through mode, the buffer controller 321 may transition from its normal rank-decoding operating state to a transparent forwarding state in which the rank-decoding logic, as described in accordance with FIGS. 3 and 4 above, is bypassed.

In an example, when pass-through mode is enabled in the buffer apparatus 341, the memory controller 303 may be configured to drive the first signal path 311 and the second signal path 312 with encoded signals directed to a further register device coupled beyond the buffer apparatus 341 operating in pass-through mode. The memory controller 303 may continue to encode the memory selection configuration onto the first signal path 311 and the second signal path 312 according to the encoding scheme as described herein, but the intended decoder of that encoding may not be the buffer apparatus 341 itself, that operates in pass-through mode, but rather a downstream register device that receives the forwarded signals and performs the rank decoding. In an example, the buffer apparatus 341 may operate in pass-through mode to pass through the QCS and/or QCA to the memory circuit 342 (e.g., DRAM device), and the memory circuit 342 may decode and operate where the base die decodes the QCS signals.

Correspondingly, the buffer controller 321 in pass-through mode forwards the signals received on the first and second signal paths of the input interface to the output interface signals 331 through 334 without performing rank decoding. The buffer controller 321 in pass-through mode may act as a transparent repeater, such that the DCS and DCA signal values received on the frontside input interface are regenerated and re-driven on the backside output interface as QCS and QCA respectively, preserving the encoded bit pattern for consumption by the downstream register device.

The signal flow in such a cascaded configuration may therefore be as the following: memory controller 303 encodes memory selection configuration onto signal paths 311 and 312, then the buffer apparatus 341 operating in pass-through mode receives, regenerates, and forwards signals without decoding, then the downstream register device receives the forwarded encoded signals and performs rank-selection decoding, the downstream register device activate its coupled memory circuit at the rank identified by the decoded memory selection configuration.

In an example, the buffer controller 321 is configured to perform a parity check on signals received via its input interface even when the buffer apparatus 341 is operating in pass-through mode. The buffer controller 321 may examine the command and address signals received on the DCA input, using a parity bit or checksum field present in the received command stream to detect transmission errors introduced on the frontside signal paths. If the buffer controller 321 detects a parity error in the received signals, the buffer controller 321 may block the command from being forwarded to the output interface, either by suppressing the QCS assertion on signal 331 or by asserting an error indication on the alert signal, to prevent the corrupted command from reaching the memory circuit 342. The parity checking function may operate independently of and in parallel with the pass-through forwarding function, so that the buffer apparatus 341 can continue to provide a signal integrity gate protecting the memory circuit 342 even in operating modes where the buffer controller 321 does not perform rank-selection decoding.

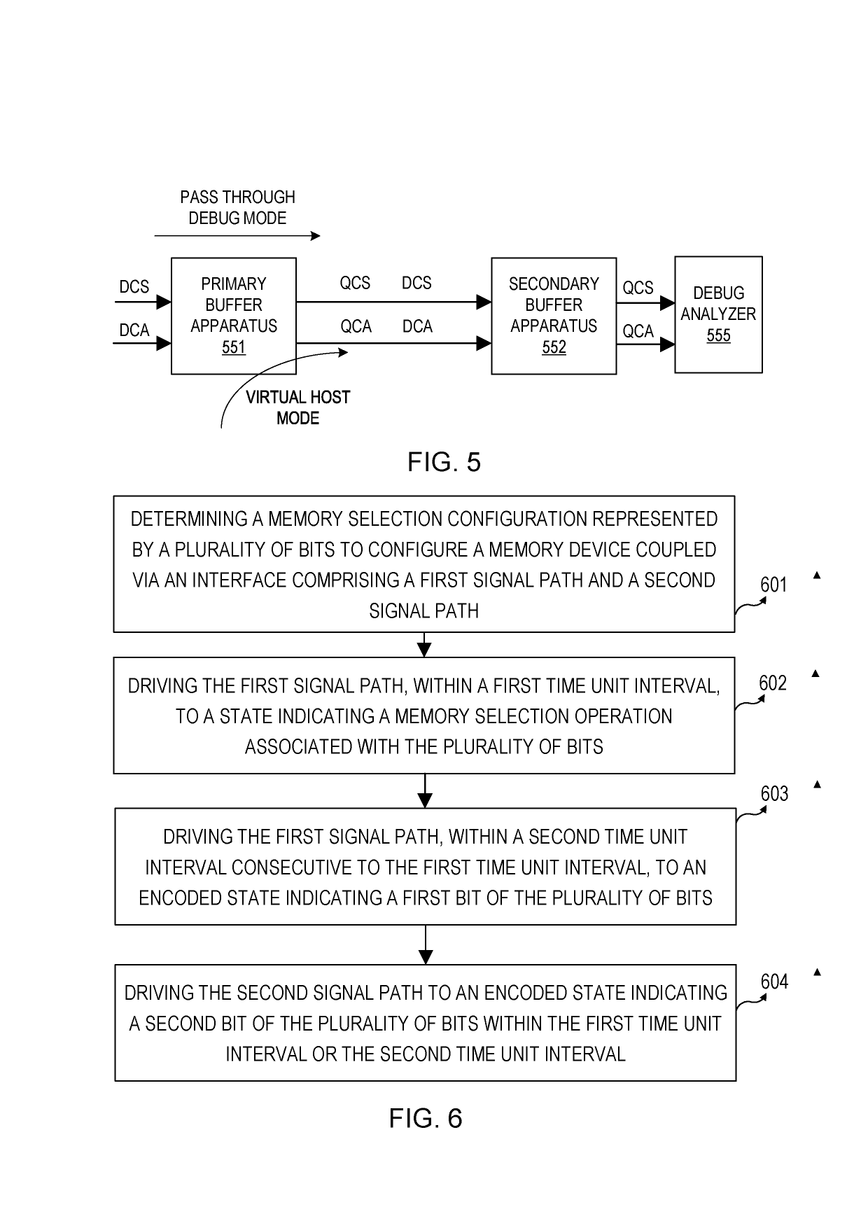

FIG. 5 illustrates a cascaded buffer apparatus configuration in accordance with aspects described herein. In this example, a memory device (e.g. the memory device 204) may include a primary buffer apparatus 551, a secondary buffer apparatus 552, and a debug analyzer 555. Each buffer apparatus may correspond to a buffer apparatus that is identical to the buffer apparatus 341, apart from that the input interface of the secondary buffer apparatus 552 is coupled to the output interface of the primary buffer apparatus. The input interface of the primary buffer apparatus 551 would be coupled to the interface of the memory controller apparatus 301, which the interface includes the first signal path and the second signal path.

The primary buffer apparatus 551 may receive the frontside DCS and DCA signals at its input interface from a memory controller, corresponding to the signals received by the buffer apparatus 341 from the memory controller apparatus 301. The primary buffer apparatus 551 may operate in pass-through mode as described above, such that the primary buffer apparatus 551 forwards the received DCS and DCA signals to its output interface as QCS and QCA respectively, without performing rank-selection decoding. The QCS and QCA outputs of the primary buffer apparatus 551 may be connected to the DCS and DCA inputs of the secondary buffer apparatus 552, forming a daisy-chain in which the primary buffer apparatus 551 functions as a signal repeater and the secondary buffer apparatus 552 functions as the active rank decoder.

The secondary buffer apparatus 552 receives the forwarded encoded signals at its input interface and performs the full rank-decoding operation described with respect to the buffer controller 321, by accumulating the encoded bits from its DCS input across UI0 and UI1, determining the memory selection configuration, and asserting the appropriate QCS output toward the connected memory device. The secondary buffer apparatus 552 can drive its decoded QCS output and regenerated QCA output to the debug analyzer 555, which receives and monitors these backside signals for validation and debugging purposes.

The primary buffer apparatus 551 can provide the same signal buffering and integrity monitoring, including parity checking, as the buffer controller 321 described in accordance with FIG. 3 in pass-through mode, while the secondary buffer apparatus 552 can execute the same three-bit decoding-to-QCS-assertion sequence as the buffer controller 321 in normal mode.

The debug analyzer 555 may be configured to observe the QCS and QCA outputs of the secondary buffer apparatus 552, enabling validation of the end-to-end encoding and decoding chain, which is from the DCS and DCA signals received at the primary buffer apparatus 551 input through the forwarded path to the decoded QCS output of the secondary buffer apparatus 552, without requiring a complete system including a processor and fully operational DRAM. This cascaded topology may be applicable to manufacturing test, design validation, and interoperability testing scenarios where the encoding scheme of the disclosed technology must be verified at full DDR6 operating speed.

In an example, the memory controller 303 is further configured to operate in a test mode in which the memory controller 303 transmits test patterns on the first signal path 311 and the second signal path 312. The test patterns may include predetermined sequences of encoded bit patterns that systematically exercise the full set of rank-selection combinations. For example, the test patterns may include cycling through all eight three-bit patterns from binary 000 through binary 111 across successive command cycles to verify that each encoded pattern is correctly conveyed across the front interface and correctly decoded by the buffer apparatus 341. The memory controller 303 may receive loopback signals returned from the buffer apparatus 341 and compare the received loopback signals against the transmitted test patterns to confirm that the encoding presented on the first signal path 311 and the second signal path 312 has been received and decoded without error.

Correspondingly, the buffer controller 321 within the buffer apparatus 341 may further be configured to operate in a virtual host test mode in which the buffer controller 321 receives command signals via a sideband interface that is physically and electrically separate from the normal input interface receiving signals on paths 311 and 312. The sideband interface may be a low-speed serial bus such as I²C, I3C, SPI, or UART. Based on the command signals received via the sideband interface, the buffer controller 321 may internally generate test patterns encoded according to the encoding scheme as described herein, and drive these test patterns on the output interface signals 331 through 334 at full DDR6 operating speed to validate the rank-selection logic. The output interface of the buffer controller 321 in virtual host mode may be connected to a downstream buffer apparatus, such as the secondary buffer apparatus 552, or to test equipment such as a logic analyzer or the debug analyzer 555, enabling end-to-end validation of the encoding and decoding chain at full operational speed without requiring a complete system including a processor and a fully operational memory circuit 342.

In an example, the memory controller apparatus 301 further includes a diagnostic interface configured to receive validation data from the buffer apparatus 341 indicating whether the plurality of bits transmitted on the first signal path 311 and the second signal path 312 has been successfully decoded. The validation data returned from the buffer apparatus 341 to the diagnostic interface of the memory controller apparatus 301 may include acknowledgment signals confirming receipt and decoding of each transmitted bit pattern, and/or error flags asserting the detection of a decoding mismatch or parity fault, and/or decoded rank-selection values that the memory controller 303 compares against the originally encoded memory selection configuration to verify correctness.

The diagnostic interface may be implemented as a dedicated sideband channel, such as an I²C or SMBus management interface, or may reuse existing alert and event signaling already present on the front interface, such as the Alert 1-bit signal shown in FIG. 4, which provides a return path from the buffer apparatus 341 to the memory controller 301 without requiring additional physical signal pins. As illustrated by the virtual host mode configuration of FIG. 5, the buffer controller 321 operating in test mode may generate encoded output patterns on the output interface that can be monitored by the debug analyzer 555, and the results of that monitoring can be communicated back to the memory controller apparatus 301 via the diagnostic interface to confirm that the full signal chain, from encoding at the memory controller 303, through transmission on signal paths 311 and 312, through reception and decoding at the buffer controller 321, through re-driving on output signals 331 through 334, operates correctly across all rank-selection combinations.

In an example, the memory controller 303 may transmit data signals to the memory circuit 342 via a data path corresponding to the memory selection configuration represented by the plurality of bits encoded on the first signal path 311 and the second signal path 312. The data path may be physically distinct from the command and chip select signal paths and may include the bidirectional DQ data lines and DQS data strobe lines, which carry read and write data between the memory controller 303 and the DRAM devices of the memory circuit 342. The correspondence between the data path and the memory selection configuration means that the data signals transmitted by the memory controller 303 on the DQ and DQS lines are directed to the specific rank, i.e. among rank-1 343A through rank-N 343N, identified by the memory selection configuration encoded on signal paths 311 and 312. For example, data signals intended for rank-3343C may be routed on the data path concurrently with the chip select encoding that causes the buffer controller 321 to assert QCS to rank-3 343C on output signal 331.

Correspondingly, the buffer controller 321 may be further configured to transmit data signals to the memory circuit 342 via the data path corresponding to the memory selection configuration determined from the plurality of bits received at the input interface. The buffer controller 321 may forward or buffer data signals on the DQ and DQS lines toward the rank identified by the decoded memory selection configuration, ensuring that data is presented to and accepted by the correct rank within the memory circuit 342.

In an example, the memory controller 303 may transmit data signals on the data path concurrently with or subsequent to driving the first signal path 311 and the second signal path 312 with the plurality of bits. For write operations, the memory controller 303 can transmit write data on the DQ lines concurrently with or immediately following the chip select encoding on signal paths 311 and 312, for example, within the timing margins specified by the DDR6 interface protocol, so that the data arrives at the target rank at the correct time relative to the WRITE command. For read operations, the memory controller 303 may issue the READ command encoding on signal paths 311 and 312 and subsequently receives read data on the DQ lines after the memory access latency has elapsed, the data emerging from the rank activated by the buffer controller 321 in response to the decoded memory selection configuration.

Correspondingly, the buffer controller 321 may be configured to forward data signals to the memory circuit 342 concurrently with or subsequent to determining the memory selection configuration. Because the buffer controller 321 completes rank decoding within the two-UI window, the buffer controller 321 can assert the QCS output on signal 331 to the correct rank, such as rank-3 343C, before or simultaneously with the arrival of the data signals at the memory circuit 342, ensuring the target rank is fully activated and ready to accept or source data when the data signals arrive. The actual routing of data to the selected rank may be performed by the DRAM devices within that rank responding to the asserted QCS signal on output 331, while all non-selected ranks remain quiescent.

The propagation delay of the buffer apparatus 341 can be defined as the elapsed time from the moment the buffer controller 321 receives a valid command and its associated rank-selection bits at the input interface, via the first signal path 311 and the second signal path 312, to the moment the buffer controller 321 drives the corresponding command and the asserted QCS signal on the output interface signals 331 through 334 toward the memory circuit 342.

Because the memory controller 303 drives all bits of the plurality, whether two bits for four-rank selection or three bits for eight-rank selection, within the two consecutive time unit intervals UI0 and UI1 on the first signal path 311 and the second signal path 312, the buffer controller 321 receives the complete memory selection configuration by the end of UI1 in all supported rank configurations. The rank-decoding logic within the buffer controller 321 can therefore complete determination of the memory selection configuration and assert the appropriate QCS output on signal 331 within the same two-UI time window regardless of whether the memory circuit 342 is organized as a four-rank or an eight-rank configuration. This means that tPDM remains constant across rank configurations: the buffer apparatus 341 serving an eight-rank memory circuit 342 achieves the same tPDM as the buffer apparatus 341 serving a four-rank memory circuit 342, because the two-UI completion window is preserved in both cases by the encoding scheme applied by the memory controller 303 to signal paths 311 and 312.

The two-UI completion window established by the memory controller 303 encoding on signal paths 311 and 312 further preserves command bus bandwidth. Because all three rank-selection bits arrive at the buffer apparatus 341 input within UI0 and UI1, the two UIs including the standard command window, no command on the front interface needs to be extended beyond its standard duration to accommodate late-arriving rank-selection bits.

In various aspects described herein, at power-on, before the memory controller 303 has transmitted any mode configuration to the buffer apparatus 341, both the memory controller 303 and the buffer controller 321 can share a common understanding of the operating mode to enable initial communication. The buffer apparatus 341 therefore can enter a designated default operating mode upon power-on, which may include the four-rank SDR encoding scheme in which the first signal path 311 carries only the command latch indication across both UI0 and UI1 and the second signal path 312 carries two rank-selection bits in DDR mode. Additionally, or alternatively, the buffer apparatus 341 may enter in a mode with a discovery and handshake protocol that the memory controller 303 and the buffer controller 321 execute to negotiate operating parameters before normal memory transactions begin. The default mode may provide the baseline from which the memory controller 303 can proceed with initial configuration of the buffer apparatus 341.

Once initial communication is established, the memory controller 303 may write to mode registers within the buffer apparatus 341 to select the desired operating mode for the current system configuration. The available modes include a first mode as the four-rank configurations, a second mode as the eight-rank configurations under conventional SDR encoding of the first signal path 311, and/or a third mode for eight-rank configurations under the DDR encoding of the first signal path 311 as described herein. The modes may further include the pass-through and test modes as described herein.

The memory controller 303 may determine the appropriate mode based on the configuration of the memory circuit 342, which may be indicated by Serial Presence Detect (SPD) data stored on the memory module and read by the memory controller 303 during the initialization sequence to identify the rank count of the installed memory circuit 342. For an eight-rank memory circuit 342, the memory controller 303 may select the mode by writing the corresponding mode register value to the buffer apparatus 341 via the sideband interface, after which the buffer controller 321 transitions from the default mode to the DDR-encoded CS operating mode.

A standard reset assertion directed to the buffer apparatus 341 does not revert the buffer controller 321 to the default power-on operating mode, because standard resets occur during normal system operation—such as during error recovery sequences—and must not disturb the programmed mode configuration that the memory controller 303 established during initialization. To intentionally return the buffer apparatus 341 to its default mode—for example, during a deliberate re-initialization sequence or following a system configuration change—the memory controller 303 executes a dedicated reset sequence that is distinguishable from a routine reset. In one example, this dedicated reset sequence includes the memory controller 303 holding both the first signal path 311 and the second signal path 312 in a predetermined logic state—such as both signals held at a logic high level—while simultaneously asserting the reset signal to the buffer apparatus 341. The buffer controller 321 recognizes this specific combination of signal states accompanying the reset assertion as the dedicated mode-reversion trigger and responds by returning to the default operating mode, whereas a reset assertion unaccompanied by this predetermined signal state is treated as a routine reset that preserves the currently programmed mode.

The principles described above, whereby the memory controller 303 drives the first signal path 311 and the second signal path 312 in DDR mode to deliver all rank-selection bits within two consecutive UIs and the buffer controller 321 decodes the complete memory selection configuration within the same two-UI window, are not limited to DDR6 RDIMM configurations. The same principles are applicable to Multiplexed Channel DIMMs (MCDIMMs) and Multiplexed Rank DIMMs (MRDIMMs), where the buffer apparatus 341 additionally multiplexes rank data paths, and to future DDR generations including DDR7 and beyond, where the specific electrical parameters and command protocols will differ but the structural relationship between command-latch and encoded rank-selection bits within a two-UI window remains applicable. The principles further extend to rank counts beyond eight: a sixteen-rank configuration would require four rank-selection bits, which may be accommodated by extending the encoding to a third signal path, by applying higher-order signaling on the existing signal paths 311 and 312, or by utilizing additional UIs on one of the existing signal paths while preserving the two-UI delivery window through corresponding protocol adjustments.

The disclosed technology admits of alternative implementations without departing from the inventive concept. The clock-edge polarity assignment is not required to be as described herein: an inverse assignment in which UI0 corresponds to the falling edge and UI1 corresponds to the rising edge is equally valid, provided the memory controller 303 and the buffer controller 321 are configured consistently. The ordering of rank-selection bits across the signal paths 311 and 312 and across UI0 and UI1 may differ from the specific assignment as described herein, provided all required bits are collectively conveyed within the two-UI window. Pass-through mode may be implemented through mechanisms other than a mode register write, including hardware configuration pins or dedicated command sequences. The sideband interface used for test mode and diagnostic functions as described herein may employ alternative protocols including USB, PCIe, or a custom serial interface in addition to the I²C and I3C examples described above. The rank-decoding logic within the buffer controller 321 may be implemented as a lookup table, combinatorial decoder circuit, or state machine, all of which are functionally equivalent for the purpose of mapping received bit patterns to rank-specific QCS assertions on output signals 331 through 334.

The encoding scheme of the disclosed technology is compatible with additional signal integrity and error management functions that may be implemented concurrently within the buffer controller 321, including CA parity checking as described herein, cyclic redundancy check (CRC) computation on command streams, and link-level retry mechanisms triggered upon error detection. The specific voltage levels, timing parameters, signal termination schemes, and electrical characteristics associated with the signal paths 311, 312, and 331 through 334 are defined by the applicable JEDEC standard and are independent of the inventive concept, which resides in the DDR operation of the first signal path 311 to carry both the command latch indication in UI0 and an encoded rank-selection bit in UI1. In some embodiments, the memory controller 303 and the buffer controller 321 may be integrated into a single package or a single die, in which case the first signal path 311 and the second signal path 312 may be implemented as on-package or on-die interconnects rather than as PCB traces at the DIMM connector interface.

In some aspects, the memory controller 303 drives the first signal path 311 and the second signal path 312 in DDR mode to deliver all rank-selection bits within two consecutive UIs and the buffer controller 321 decodes the complete memory selection configuration within the same two-UI window, noting that these aspects are not limited to DDR6 RDIMM configurations. The same principles are applicable to Multiplexed Channel DIMMs (MCDIMMs) and Multiplexed Rank DIMMs (MRDIMMs), where the buffer apparatus 341 additionally multiplexes rank data paths, and to future DDR generations including DDR7 and beyond, where the specific electrical parameters and command protocols might differ but the structural relationship between command-latch and encoded rank-selection bits within a two-UI window remains applicable. The principles further extend to rank counts beyond eight: a sixteen-rank configuration would require four rank-selection bits, which may be accommodated by extending the encoding to a third signal path, by applying higher-order signaling on the existing signal paths 311 and 312, or by utilizing additional UIs on one of the existing signal paths while preserving the two-UI delivery window through corresponding protocol adjustments.

In various aspects, clock-edge polarity assignment might not be required. For example, an inverse assignment in which UI0 corresponds to the falling edge and UI1 corresponds to the rising edge might be equally valid, provided the memory controller 303 and the buffer controller 321 are configured consistently. The ordering of rank-selection bits across the signal paths 311 and 312 and across UI0 and UI1 may differ from the various assignments as described herein, provided all required bits are collectively conveyed within the two-UI window. In some examples, pass-through mode may be implemented through mechanisms other than a mode register write, including hardware configuration pins or dedicated command sequences. In some aspects, the sideband interface used for test mode and diagnostic functions as described herein, may employ alternative protocols including USB, PCIe, or a custom serial interface in addition to the I²C and I3C examples described above. The rank-decoding logic within the buffer controller 321 may be implemented as a lookup table, combinatorial decoder circuit, or state machine, all of which are functionally equivalent for the purpose of mapping received bit patterns to rank-specific QCS assertions on output signals 331 through 334.

Various aspects described herein, including the described encoding scheme, is compatible with additional signal integrity and error management functions that may be implemented concurrently within the buffer controller 321, including CA parity checking as described herein, cyclic redundancy check (CRC) computation on command streams, and link-level retry mechanisms triggered upon error detection. The specific voltage levels, timing parameters, signal termination schemes, and electrical characteristics associated with the signal paths 311, 312, and 331 through 334 can be defined by the applicable JEDEC standard. In some examples, this resides in the DDR operation of the first signal path 311 to carry both the command latch indication in UI0 and an encoded rank-selection bit in UI1. In some embodiments, the memory controller 303 and the buffer controller 321 may be integrated into a single package or a single die, in which case the first signal path 311 and the second signal path 312 may be implemented as on-package or on-die interconnects rather than as PCB traces at the DIMM connector interface.

FIG. 6 shows an example of a method. The method may include: determining 601 a memory selection configuration represented by a plurality of bits to configure a memory device coupled via an interface including a first signal path and a second signal path; driving 602 the first signal path, within a first time unit interval, to a state indicating a memory selection operation associated with the plurality of bits; driving 603 the first signal path, within a second time unit interval consecutive to the first time unit interval, to an encoded state indicating a first bit of the plurality of bits; and driving 604 the second signal path to an encoded state indicating a second bit of the plurality of bits within the first time unit interval or the second time unit interval. A non-transitory computer-readable medium including instructions which, if executed by a controller, perform the method.

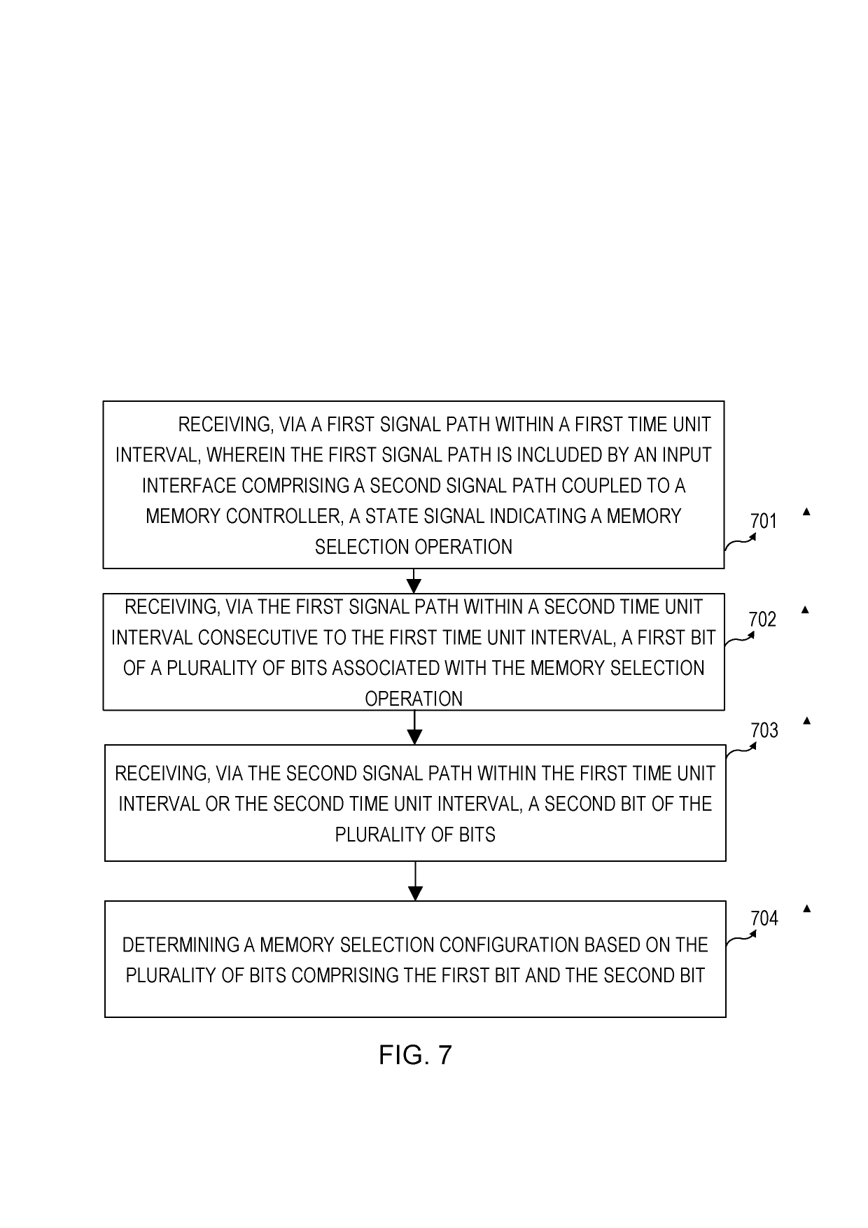

FIG. 7 shows an example of a method. The method may include: receiving 701, via a first signal path within a first time unit interval, wherein the first signal path is included by an input interface including a second signal path coupled to a memory controller, a state signal indicating a memory selection operation; receiving 702, via the first signal path within a second time unit interval consecutive to the first time unit interval, a first bit of a plurality of bits associated with the memory selection operation; receiving 703, via the second signal path within the first time unit interval or the second time unit interval, a second bit of the plurality of bits; and determining 704 a memory selection configuration based on the plurality of bits including the first bit and the second bit. A non-transitory computer-readable medium including instructions which, if executed by a controller, perform the method.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word "exemplary" is used herein to mean "serving as an example, instance, or illustration". Any aspect or design described herein as "exemplary" is not necessarily to be construed as preferred or advantageous over other aspects or designs.

The phrase “at least one” and “one or more” may be understood to include a numerical quantity greater than or equal to one (e.g., one, two, three, four, […], etc.). The phrase "at least one of" with regard to a group of elements may be used herein to mean at least one element from the group consisting of the elements. For example, the phrase "at least one of" with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, […], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as "beneath," "below," "lower," "above," "upper" and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

As utilized herein, terms "module", "component," "system," "circuit," "element," "slice," "circuitry," and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term "set" can be interpreted as "one or more."

It will be understood that when an element is referred to as being "connected" or "coupled" to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being "applied" to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 may include the subject matter of an apparatus including: an interface including a first signal path and a second signal path coupled to a memory device; a controller configured to: determine a memory selection configuration represented by a plurality of bits; drive the first signal path, within a first time unit interval, to a state indicating a memory selection operation associated with the plurality of bits; drive the first signal path, within a second time unit interval consecutive to the first time unit interval, to an encoded state indicating a first bit of the plurality of bits; and drive the second signal path to an encoded state indicating a second bit of the plurality of bits within the first time unit interval or the second time unit interval.

Example 2 may include the subject matter of example 1, wherein the first time unit interval and the second time unit interval correspond to opposite edges of a clock signal.

Example 3 may include the subject matter of example 2, wherein the second signal path is driven to deliver encoded bits on both edges of the clock signal within the first time unit interval and the second time unit interval.

Example 4 may include the subject matter of example 3, wherein the first time unit interval correspond to a rising edge of the clock signal and the second time unit interval correspond to a falling edge of the clock signal.

Example 5 may include the subject matter of any one of examples 1 to 4, wherein the plurality of bits includes three bits, wherein the second signal path is driven to the encoded state indicating the second bit of the plurality of bits within one of the first time unit interval or the second time unit interval, and wherein the controller is further configured to drive the second signal path to an encoded state indicating a third bit of the plurality of bits within other one of the first time unit interval or the second time unit interval.

Example 6 may include the subject matter of example 5, wherein the memory selection configuration represents a selection of one of more than four ranks of the memory device.

Example 7 may include the subject matter of any one of examples 1 to 6, wherein the controller is configured to drive the first and second signal paths to collectively convey all bits of the plurality of bits within two consecutive time unit intervals.

Example 8 may include the subject matter of any one of examples 1 to 7, wherein the first signal path and the second signal path are coupled to a register device coupled between the interface and the memory device.

Example 9 may include the subject matter of example 8, wherein the controller is further configured to transmit a mode control signal to enable a pass-through mode in the register device coupled between the interface and the memory device.

Example 10 may include the subject matter of example 9, wherein when the pass-through mode is enabled, the controller is configured to drive the first signal path and the second signal path with encoded signals directed to a further register device coupled beyond the register device operating in pass-through mode.

Example 11 may include the subject matter of any one of examples 8 to 10, wherein the controller is further configured to operate in a test mode in which the controller transmits test patterns on the first signal path and the second signal path and receives loopback signals from the register device to validate encoding and decoding of the plurality of bits.

Example 12 may include the subject matter of any one of examples 8 to 11, wherein the controller further includes a diagnostic interface configured to receive validation data from a register device indicating successful decoding of the plurality of bits transmitted on the first and second signal paths.

Example 13 may include the subject matter of any one of examples 1 to 12, wherein the controller is further configured to transmit data signals to the memory device via a data path corresponding to the memory selection configuration represented by the plurality of bits.

Example 14 may include the subject matter of example 13, wherein the controller is configured to transmit the data signals on the data path concurrently with or subsequent to driving the first and second signal paths with the plurality of bits.

Example 15 may include the subject matter of an apparatus including: an input interface including a first signal path and a second signal path coupled to a memory controller; a controller configured to: receive, via the first signal path within a first time unit interval, a state signal indicating a memory selection operation; receive, via the first signal path within a second time unit interval consecutive to the first time unit interval, a first bit of a plurality of bits associated with the memory selection operation; receive, via the second signal path within the first time unit interval or the second time unit interval, a second bit of the plurality of bits; determine a memory selection configuration based on the plurality of bits including the first bit and the second bit.

Example 16 may include the subject matter of example 15, wherein the first time unit interval and the second time unit interval correspond to opposite edges of a clock signal.

Example 17 may include the subject matter of example 16, wherein the controller is configured to receive encoded bits from the second signal path on both edges of the clock signal within the first unit interval and the second time unit interval.

Example 18 may include the subject matter of example 17, wherein the first time unit interval corresponds to a rising edge of the clock signal and the second time unit interval correspond to a falling edge of the clock signal.

Example 19 may include the subject matter of any one of examples 15 to 18, wherein the plurality of bits includes three bits, wherein the controller is configured to receive the second bit within one of the first time unit interval or the second time unit interval and receive a third bit within other one of the first time unit interval or the second time unit interval.

Example 20 may include the subject matter of any one of examples 15 to 19, may further include an output interface coupled to the memory device, wherein the controller acts as a registering clock driver buffer between the input interface and the memory device.

Example 21 may include the subject matter of example 20, wherein the controller is further configured to receive a mode control signal and enable, in response to the mode control signal, a pass-through mode.

Example 22 may include the subject matter of example 21, wherein the controller is further configured to forward signals received on the first signal path and the second signal path to the output interface without decoding the memory selection configuration.

Example 23 may include the subject matter of any one of examples 20 to 22, wherein the controller is further configured to operate in a test mode in which the controller receives command signals via a sideband interface, generates test patterns based on the command signals, and outputs the test patterns via the output interface to validate rank selection logic.

Example 24 may include the subject matter of any one of examples 20 to 23, wherein the controller is configured to perform a parity check on signals received via the input interface and block commands to the memory device if a parity error is detected.

Example 25 may include the subject matter of any one of examples 15 to 24, wherein the controller is further configured to transmit data signals to the memory device via a data path corresponding to the memory selection configuration represented by the plurality of bits.

Example 26 may include the subject matter of example 25, wherein the controller is configured to forward the data signals to the memory device concurrently with or subsequent to determining the memory selection configuration.

Example 27 may include the subject matter of a method including: determining a memory selection configuration represented by a plurality of bits to configure a memory device coupled via an interface including a first signal path and a second signal path; driving the first signal path, within a first time unit interval, to a state indicating a memory selection operation associated with the plurality of bits; driving the first signal path, within a second time unit interval consecutive to the first time unit interval, to an encoded state indicating a first bit of the plurality of bits; and driving the second signal path to an encoded state indicating a second bit of the plurality of bits within the first time unit interval or the second time unit interval.

Example 28 may include the subject matter of example 27, wherein the first time unit interval and the second time unit interval correspond to opposite edges of a clock signal.

Example 29 may include the subject matter of example 28, wherein the second signal path is driven to deliver encoded bits on both edges of the clock signal within the first time unit interval and the second time unit interval.

Example 30 may include the subject matter of example 29, wherein the first time unit interval correspond to a rising edge of the clock signal and the second time unit interval correspond to a falling edge of the clock signal.

Example 31 may include the subject matter of any one of examples 27 to 30, wherein the plurality of bits includes three bits, wherein the second signal path is driven to the encoded state indicating the second bit of the plurality of bits within one of the first time unit interval or the second time unit interval, and wherein the controller is further configured to drive the second signal path to an encoded state indicating a third bit of the plurality of bits within other one of the first time unit interval or the second time unit interval.

Example 32 may include the subject matter of example 31, wherein the memory selection configuration represents a selection of one of more than four ranks of the memory device.

Example 33 may include the subject matter of any one of examples 27 to 32, may further include driving the first and second signal paths to collectively convey all bits of the plurality of bits within two consecutive time unit intervals.

Example 34 may include the subject matter of any one of examples 27 to 33, wherein the first signal path and the second signal path are coupled to a register device coupled between the interface and the memory device.

Example 35 may include the subject matter of example 34, may further include transmitting a mode control signal to enable a pass-through mode in the register device coupled between the interface and the memory device.

Example 36 may include the subject matter of example 35, may further include, when the pass-through mode is enabled, driving the first signal path and the second signal path with encoded signals directed to a further register device coupled beyond the register device operating in pass-through mode.

Example 37 may include the subject matter of any one of examples 34 to 36, may further include operating in a test mode in which the controller transmits test patterns on the first signal path and the second signal path and receives loopback signals from the register device to validate encoding and decoding of the plurality of bits.

Example 38 may include the subject matter of any one of examples 34 to 37, may further include receiving, via a diagnostic interface, validation data from a register device indicating successful decoding of the plurality of bits transmitted on the first and second signal paths.

Example 39 may include the subject matter of any one of examples 27 to 38, may further include transmitting data signals to the memory device via a data path corresponding to the memory selection configuration represented by the plurality of bits.

Example 40 may include the subject matter of example 39, may further include transmitting the data signals on the data path concurrently with or subsequent to driving the first and second signal paths with the plurality of bits.

Example 41 may include the subject matter of a method including: receiving, via a first signal path within a first time unit interval, wherein the first signal path is included by an input interface including a second signal path coupled to a memory controller, a state signal indicating a memory selection operation; receiving, via the first signal path within a second time unit interval consecutive to the first time unit interval, a first bit of a plurality of bits associated with the memory selection operation; receiving, via the second signal path within the first time unit interval or the second time unit interval, a second bit of the plurality of bits; determining a memory selection configuration based on the plurality of bits including the first bit and the second bit.

Example 42 may include the subject matter of example 41, wherein the first time unit interval and the second time unit interval correspond to opposite edges of a clock signal.

Example 43 may include the subject matter of example 42, may further include receiving encoded bits from the second signal path on both edges of the clock signal within the first unit interval and the second time unit interval.

Example 44 may include the subject matter of example 43, wherein the first time unit interval corresponds to a rising edge of the clock signal and the second time unit interval correspond to a falling edge of the clock signal.

Example 45 may include the subject matter of any one of examples 41 to 44, wherein the plurality of bits includes three bits, wherein the method further includes receiving the second bit within one of the first time unit interval or the second time unit interval and receiving a third bit within other one of the first time unit interval or the second time unit interval.

Example 46 may include the subject matter of any one of examples 41 to 45, may further include an output interface coupled to the memory device, wherein the controller acts as a registering clock driver buffer between the input interface and the memory device.

Example 47 may include the subject matter of example 46, may further include receiving a mode control signal and enable, in response to the mode control signal, a pass-through mode.

Example 48 may include the subject matter of example 47, may further include forwarding signals received on the first signal path and the second signal path to the output interface without decoding the memory selection configuration.

Example 49 may include the subject matter of any one of examples 46 to 48, may further include operating in a test mode in which the controller receives command signals via a sideband interface, generates test patterns based on the command signals, and outputs the test patterns via the output interface to validate rank selection logic.

Example 50 may include the subject matter of any one of examples 46 to 49, may further include performing a parity check on signals received via the input interface and block commands to the memory device if a parity error is detected.

Example 51 may include the subject matter of any one of examples 41 to 50, may further include transmitting data signals to the memory device via a data path corresponding to the memory selection configuration represented by the plurality of bits.

Example 52 may include the subject matter of example 51, may further include forwarding the data signals to the memory device concurrently with or subsequent to determining the memory selection configuration.

Example 53 may include a non-transitory computer readable medium including instructions which, if executed by a controller of a computing device, cause the controller to perform the method of examples 27 to 40 or the method of examples 41 to 52.

Example 54 may include an apparatus including means to perform the methods of any one of examples 27 to 52.

What is claimed is:

1. An apparatus comprising:
an interface comprising a first signal path and a second signal path coupled to a memory device;
a controller configured to:
determine a memory selection configuration represented by a plurality of bits;
drive the first signal path, within a first time unit interval, to a state indicating a memory selection operation associated with the plurality of bits;
drive the first signal path, within a second time unit interval consecutive to the first time unit interval, to an encoded state indicating a first bit of the plurality of bits; and
drive the second signal path to an encoded state indicating a second bit of the plurality of bits within the first time unit interval or the second time unit interval.

2. The apparatus of claim 1, wherein the first time unit interval and the second time unit interval correspond to opposite edges of a clock signal.

3. The apparatus of claim 2, wherein the second signal path is driven to deliver encoded bits on both edges of the clock signal within the first time unit interval and the second time unit interval.

4. The apparatus of claim 3, wherein the first time unit interval correspond to a rising edge of the clock signal and the second time unit interval correspond to a falling edge of the clock signal.

5. The apparatus of claim 1, wherein the plurality of bits comprises three bits, wherein the second signal path is driven to the encoded state indicating the second bit of the plurality of bits within one of the first time unit interval or the second time unit interval, and wherein the controller is further configured to drive the second signal path to an encoded state indicating a third bit of the plurality of bits within other one of the first time unit interval or the second time unit interval.

6. The apparatus of claim 5, wherein the memory selection configuration represents a selection of one of more than four ranks of the memory device.

7. The apparatus of claim 1, wherein the first signal path and the second signal path are coupled to a register device coupled between the interface and the memory device.

8. The apparatus of claim 7, wherein the controller is further configured to transmit a mode control signal to enable a pass-through mode in the register device coupled between the interface and the memory device.

9. The apparatus of claim 8, wherein when the pass-through mode is enabled, the controller is configured to drive the first signal path and the second signal path with encoded signals directed to a further register device coupled beyond the register device operating in pass-through mode.

10. The apparatus of claim 1, wherein the controller is further configured to transmit data signals to the memory device via a data path corresponding to the memory selection configuration represented by the plurality of bits.

11. The apparatus of claim 10, wherein the controller is configured to transmit the data signals on the data path concurrently with or subsequent to driving the first and second signal paths with the plurality of bits.

12. An apparatus comprising:
an input interface comprising a first signal path and a second signal path coupled to a memory controller;
a controller configured to:
receive, via the first signal path within a first time unit interval, a state signal indicating a memory selection operation;
receive, via the first signal path within a second time unit interval consecutive to the first time unit interval, a first bit of a plurality of bits associated with the memory selection operation;
receive, via the second signal path within the first time unit interval or the second time unit interval, a second bit of the plurality of bits;
determine a memory selection configuration based on the plurality of bits comprising the first bit and the second bit.

13. The apparatus of claim 12, wherein the first time unit interval and the second time unit interval correspond to opposite edges of a clock signal.

14. The apparatus of claim 12, wherein the plurality of bits comprises three bits, wherein the controller is configured to receive the second bit within one of the first time unit interval or the second time unit interval and receive a third bit within other one of the first time unit interval or the second time unit interval.

15. The apparatus of claim 12, further comprising an output interface coupled to the memory device, wherein the controller acts as a registering clock driver buffer between the input interface and the memory device.

16. The apparatus of claim 15, wherein the controller is further configured to receive a mode control signal and enable, in response to the mode control signal, a pass-through mode.

17. The apparatus of claim 16, wherein the controller is further configured to forward signals received on the first signal path and the second signal path to the output interface without decoding the memory selection configuration.

18. The apparatus of claim 12, wherein the controller is further configured to transmit data signals to the memory device via a data path corresponding to the memory selection configuration represented by the plurality of bits.

19. A method comprising:
determining a memory selection configuration represented by a plurality of bits to configure a memory device coupled via an interface comprising a first signal path and a second signal path;
driving the first signal path, within a first time unit interval, to a state indicating a memory selection operation associated with the plurality of bits;
driving the first signal path, within a second time unit interval consecutive to the first time unit interval, to an encoded state indicating a first bit of the plurality of bits; and
driving the second signal path to an encoded state indicating a second bit of the plurality of bits within the first time unit interval or the second time unit interval.

20. The method of claim 19, wherein the first time unit interval and the second time unit interval correspond to opposite edges of a clock signal.
